(19) United States
(12) Patent Application Publication
(10) Pub. No.: US 2013/0064446 A1
(43) Pub. Date: Mar. 14, 2013

(54) IMAGE PROCESSING APPARATUS, IMAGE PROCESSING METHOD, AND NON-TRANSITORY COMPUTER READABLE MEDIUM

(71) Applicant: Atsushi ITOH, Kanagawa (JP)

(72) Inventor: Atsushi ITOH, Kanagawa (JP)

(73) Assignee: FUJI XEROX CO., LTD., Tokyo (JP)

(21) Appl. No.: 13/365,853

(22) Filed: Feb. 3, 2012

(30) Foreign Application Priority Data
Sep. 9, 2011 (JP) 2011-197374

(51) Int. Cl. G06K 9/00

(52) U.S. Cl. 382/165

(57) ABSTRACT

Provided is an image processing apparatus including a calculation unit that calculates, as a foreground feature vector, a feature vector indicating a difference between colors of pixels in a predetermined region including a target pixel and a color of the target pixel, using each of the pixels as the target pixel, a determination unit that determines whether to integrate two pixels or regions to be integrated, depending on similarity of the foreground feature vectors with respect to the two pixels or regions, and an integration unit that integrates the two pixels or regions determined to be integrated by the determination unit.

### CROSS-REFERENCE TO RELATED APPLICATIONS

This application is based on and claims priority under 35 USC 119 from Japanese Patent Application No. 2011-197374 filed Sep. 9, 2011.

### BACKGROUND

(i) Technical Field

The present invention relates to an image processing apparatus, an image processing method, and a non-transitory computer readable medium.

(ii) Related Art

In processes when colors of a color image are limited or color regions are divided, regions of colors gathering in a certain color region are extracted, the colors of the regions are replaced by representative colors, or division into such color regions is performed. When such processes are performed, a bundle of regions in which a certain color is originally used is preferably extracted as one region, but may be extracted as a region having a partially different color.

For example, in an image which is read by an image reading apparatus, colors which do not exist in an original image may be generated in the color boundary due to a reading error. In addition, when encoding is performed using an encoding system or a compression system making use of a method of performing frequency transform and quantization for each block indiscrete cosine transform, discrete Fourier transform or the like, high-frequency components are lost, and portions influenced by adjacent colors may be generated in the color boundary portion. Even when a smoothing process is performed, portions influenced by the adjacent colors maybe generated in the color boundary portion. As an example thereof, the color of black thin line drawn on the white background is lighter than the black color which is originally used. Further, in an image in which a high-pass filter process is performed, the difference in the colors may occur in the connection portion between the thin line and the thick line.

When the color region is extracted from the image in which deterioration occurs, a region having a color which does not originally exist may be extracted from the deteriorated portion. In this case, the region extracted from the deteriorated portion is divided as another color region, or the color of the region is replaced by a color which is not originally used.

### SUMMARY

According to an aspect of the invention, there is provided an image processing apparatus including: a calculation unit that calculates, as a foreground feature vector, a feature vector indicating a difference between colors of pixels in a predetermined region including a target pixel and a color of the target pixel, using each of the pixels as the target pixel; a determination unit that determines whether to integrate two pixels or regions to be integrated, depending on similarity of the foreground feature vectors with respect to the two pixels or regions; and an integration unit that integrates the two pixels or regions determined to be integrated by the determination unit.

### BRIEF DESCRIPTION OF THE DRAWINGS

Exemplary embodiments of the present invention will be described in detail based on the following figures, wherein:

FIG. 1 is a configuration diagram illustrating a first exemplary embodiment of the invention;

FIG. 2 is a flow diagram illustrating an example of an operation in the first exemplary embodiment of the invention;

FIGS. 3A to 3E are explanatory diagrams illustrating a specific example of the operation in the first exemplary embodiment of the invention;

FIG. 4 is a configuration diagram illustrating a first modified example in the first exemplary embodiment of the invention;

FIG. 5 is an explanatory diagram illustrating an example of the degree of inclusion;

FIG. 6 is a configuration diagram illustrating a second modified example in the first exemplary embodiment of the invention;

FIGS. 7A and 7B are explanatory diagrams illustrating a specific example of the second modified example in the first exemplary embodiment of the invention;

FIG. 8 is a configuration diagram illustrating a third modified example in the first exemplary embodiment of the invention;

FIG. 9 is an explanatory diagram illustrating a specific example of the third modified example in the first exemplary embodiment of the invention;

FIG. 10 is a configuration diagram illustrating a second exemplary embodiment of the invention;

FIG. 11 is a flow diagram illustrating an example of an operation in the second exemplary embodiment of the invention;

FIGS. 12A to 12D are explanatory diagrams illustrating a specific example of the operation in the second exemplary embodiment of the invention; and

FIG. 13 is an explanatory diagram illustrating an example of a computer program when functions described in each of the exemplary embodiments of the invention and the modified examples thereof are realized by a computer program, a recording medium having the computer program stored thereon, and a computer.

### DETAILED DESCRIPTION

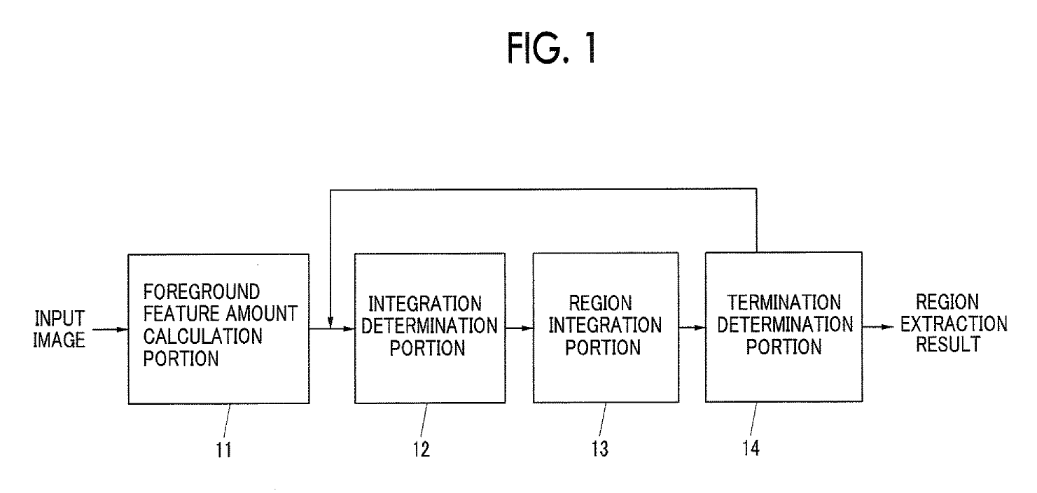

FIG. 1 is a configuration diagram illustrating a first exemplary embodiment of the invention. In the drawing, 11 denotes a foreground feature amount calculation portion, 12 denotes an integration determination portion, 13 denotes a region integration portion, and 14 denotes a termination determination portion. The foreground feature amount calculation portion 11 calculates, as a foreground feature vector, a feature vector indicating the difference between colors of pixels in a predetermined region including a target pixel and a color of the target pixel, using each of the pixels as the target pixel. Here, the foreground feature amount calculation portion calculates, as the foreground feature vector, the vector in a color space from the average color of the colors of the pixels in the predetermined region to the color of the target pixel. The size of the range on an image at the time of calculating the average color may be a size capable of obtaining a background color as the average color, when pixels other than the background in which deterioration occurs are set to the target pixel.

The integration determination portion 12 determines whether to integrate two pixels or regions to be integrated, depending on the similarity of the foreground feature vectors with respect to the two pixels or regions. The two pixels or regions to be integrated are a combination of the image pixels or regions (pixels, regions including plural pixels, and regions and pixels) which are adjacent to each other on. Whether to integrate each of the combinations thereof may be determined. There are various methods of calculating the similarity from the foreground feature vector. However, for example, since the foreground feature vector has a length and a direction, the similarity may be calculated by a function and the like based on the length and the direction of the foreground feature vector. Of course, other methods may be used. Whether to perform the integration by comparing the obtained similarity with a preset value may be determined. Meanwhile, when whether to perform the integration is determined, it may also be determined whether to perform the integration using the feature amount other than the foreground feature vector, for example, the thickness, width, or length of the region, the color of the region or the pixel, the positional relationship, the degree of inclusion, the area, and the like.

The region integration portion 13 integrates two pixels or regions determined to be integrated by the integration determination portion 12 into one region. At the time of the integration, the foreground feature vectors of the integrated regions are calculated using both foreground feature vectors. For example, the vector of the average weighted by the number of pixels is calculated, and may be set to a new foreground feature vector. Alternatively, any of the foreground feature vectors to be integrated is selected, and may be set to the foreground feature vector after the integration. For example, the foreground feature vector of the region having the larger number of pixels of two regions to be integrated may be selected.

The termination determination portion 14 determines whether the integration process is terminated. For example, when the pixels or the regions integrated by the region integration portion 13 do not exist, the integration process may be determined to be terminated. Alternatively, whether the number of existing pixels or regions is a preset number or less may be set to a condition of the termination determination. Of course, in addition to this, various termination conditions may be set, and the termination of the process maybe determined by the termination conditions. When the process is determined not to be terminated, the process returns to the integration determination portion 12, and the determination of whether to integrate the regions or the pixels after the integration in the region integration portion 13 and the process of the integration are repeatedly performed. When the termination condition is satisfied, a separation result of the color region is output.

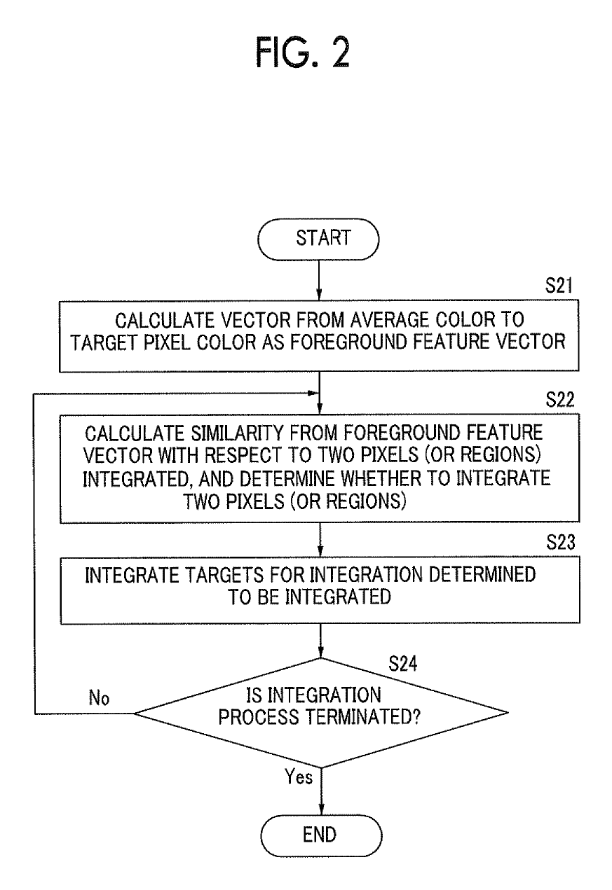

FIG. 2 is a flow diagram illustrating an example of an operation in the first exemplary embodiment of the invention. In step S21, the foreground feature amount calculation portion 11 calculates, as a foreground feature vector, a feature vector indicating the difference between colors of pixels in a predetermined region including a target pixel and a color of the target pixel, using each of the pixels as the target pixel. For example, the foreground feature amount calculation portion calculates, as the foreground feature vector, the vector in a color space from the average color of the colors of the pixels in the predetermined region to the color of the target pixel.

In step S22, the integration determination portion 12 determines whether to integrate two pixels or regions to be integrated, depending on the similarity of the foreground feature vector with respect to the two pixels or regions . Initially, whether to integrate each of the combination of two pixels adjacent to each other by obtaining the similarity from two foreground feature vectors is determined. For example, when an evaluation function indicating the similarity is set to F using the angle θ between two foreground feature vectors and the difference Δ in the lengths thereof, the similarity is obtained by the following expression.

F(θ, Δ)=α·θ+β·Δ

Where, α and β are constants, and are preferably set in advance. As the angle between the two foreground feature vectors decreases and the difference in the lengths thereof decreases, it is shown that the colors of two pixels become more similar to each other, and the value of the evaluation function F becomes smaller. when the obtained similarity is predetermined threshold or less, it may be determined that the integration is performed. Of course, it goes without saying that whether to perform the integration is not limited to the above-mentioned evaluation function F.

In step S23, the region integration portion 13 integrates two pixels or regions determined to be integrated by the integration determination portion 12 into one region. At the time of the integration, the foreground feature vectors of the integrated regions are calculated using both foreground feature vectors. For example, the vector of the average weighted by the number of pixels is calculated, and may be set to a new foreground feature vector.

In step S24, the termination determination portion 14 determines whether the integration processing is terminated. For example, under the termination condition of no combination to be integrated which is determined to be integrated by the integration determination portion 12 and no pixel or region integrated by the region integration portion 13, the process is repeated returning to step S22 when this termination condition is not satisfied.

In the process of the integration determination portion 12 in the second or subsequent step S22, the regions integrated by the region integration portion 13 exist, targets to be integrated are combinations of pixels and pixel, pixels and regions, and regions and regions which are adjacent to each other. Since the foreground feature vector is updated in the region integration portion 13 with respect to the integrated regions, whether to perform the integration using the updated foreground feature vector is determined.

The combinations of pixels and pixels, pixels and regions, and regions and regions which are determined to be integrated are integrated by the process of the region integration portion 13 in step S23, and the foreground feature vector is updated.

In step S24, whether the termination determination portion 14 satisfies the termination condition is determined. When the termination condition is satisfied, the process returns to step S22 again, and the determination of the integration and the process of the integration are repeatedly performed. When it is determined that the termination condition is satisfied, this process is terminated and the integration result so far is output.

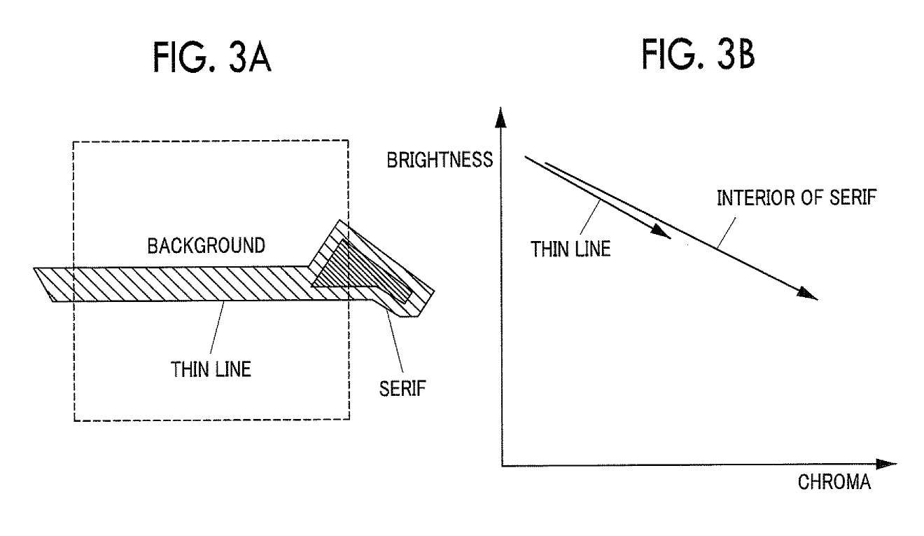

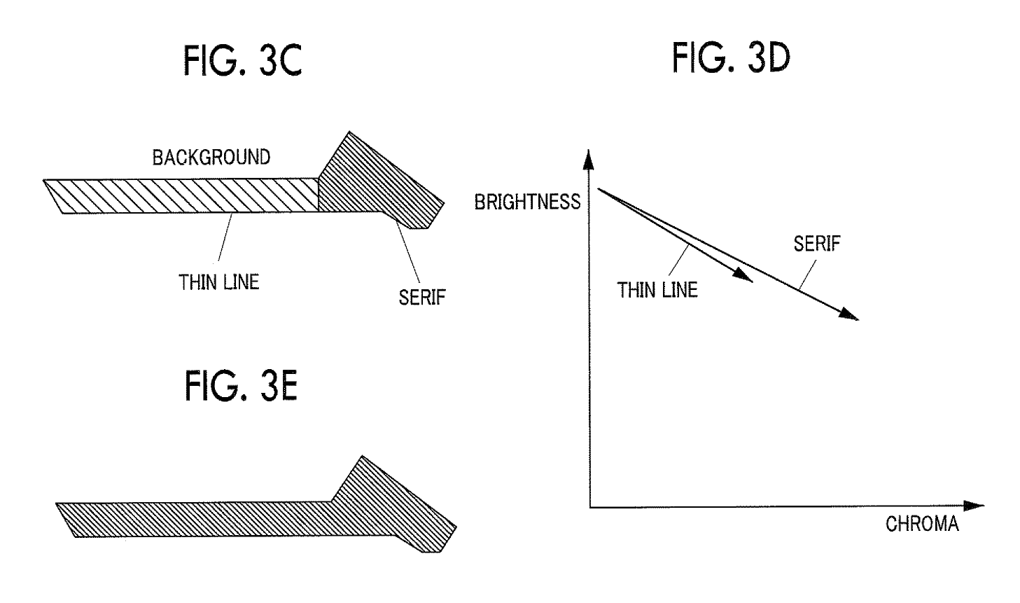

FIGS. 3A to 3E are explanatory diagrams illustrating a specific example of the operation in the first exemplary embodiment of the invention. FIG. 3A shows a portion of the image to be processed. In this example, a serif used in characters in the Mincho typeface with a certain color (called a foreground color) is present in the thin line and the termination portion of the white background. In this example, the color of the thin-line portion becomes lighter than the original foreground color under the influence of the white background due to various deterioration factors. In addition, while the serif portion is influenced by the white background in the boundary portion with the background, the original foreground color is reproduced in the inside thereof. Meanwhile, for convenience of illustration, the difference in the colors is shown as the difference in the diagonal lines.

In step S21 of FIG. 2, the foreground feature amount calculation portion 11 calculates the foreground feature vector in each of the pixels. For example, when the range having a size shown by the dashed line in FIG. 3A is set centered on each of the pixels and the average color of the colors of the pixels in the region is obtained, the number of pixels of the background color is larger than the number of pixels of the other colors. Therefore, the average color of any of the pixels becomes a background color or a color which is colored from the background color. The foreground feature vector is set to a vector in the color space in which such an average color is used as a starting point and the color of each of the pixels is used as an ending point.

An example of the foreground feature vector obtained in this manner is shown in FIG. 3B. FIG. 3B shows a brightness-chroma plane in a certain hue in the color space. The same figure shows an example of the foreground feature vector obtained in a certain pixel of the thin-line portion and an example of the foreground feature vector obtained in a certain pixel of the interior of the serif. The foreground feature vector in the pixel of the thin line and the foreground feature vector in the pixel of the interior of the serif are different from each other in length, but are same as each other in direction within a certain region. Meanwhile, for the pixel of the background color, the vector from the average color to the background color of each of the pixels becomes a foreground feature vector, but this foreground feature vector is different from the foreground feature vector shown in FIG. 3B in length and direction.

In the determination process of the integration by the integration determination portion 12 in step S22 of FIG. 2, when the integration is determined by the combination of the pixel adjacent to each other, it is determined that the integration is performed by the similarity of the foreground feature vectors in the thin-line portion. In addition, the foreground feature vectors are also similar to each other in the interior of the serif, and thus it is determined that the integration is performed. The pixels in the boundary portion with the background of serif are adjacent to the pixels in the interior of the serif, and the integration with the pixels in the interior of the serif is determined. In the combination of these pixels, the foreground feature vectors have a relationship shown in FIG. 3B, and the angle between the foreground vectors is in a certain range. Therefore, here, the vectors are similar to each other, and it is determined that the integration is performed.

In step S23 of FIG. 2, the region integration portion 13 performs the integration process in accordance with the determination result of the integration determination portion 12. For example, as shown in FIG. 3C, the pixels of the thin-line portion are integrated with each other, and in the serif portion, the pixels of the boundary portion with the background and the interior pixels are integrated with each other. Meanwhile, for the background, the pixels of the background are integrated with each other as the regions of the background. At the time of the integration, the foreground feature vectors of the regions after the integration are obtained. For example, the vector of the average weighted in the foreground feature vector by the number of pixels is calculated, and may be set to a new foreground feature vector. In the thin-line portion, the vector of the average of the foreground feature vectors similar to the vector exemplified as the foreground feature vector of the thin line in FIG. 3B becomes a new foreground feature vector. The vector of the serif portion is similar to a vector averaged from the vector exemplified as the foreground feature vector of the interior of the serif in FIG. 3B to the vector exemplified as the foreground feature vector of the thin line. Alternatively, the foreground feature vector of the interior of the serif is selected, and may be set to the foreground feature vector after the integration. An example of the integrated foreground feature vector is shown in FIG. 3D.

Returning to step S22 of FIG. 2 again, the determination of the integration is performed on the combination of each of the regions by the integration determination portion 12. When it is determined that the thin-line region and the serif region are integrated with each other, the angle between both foreground feature vectors shown in FIG. 3D is in a certain range and the vectors are similar to each other. Thereby, it is determined that the integration is performed. The thin line and the background, and the serif and the background, other than this, are determined not to be integrated because the foreground feature vectors are not similar to each other.

This determination result is received, and then in step S23 of FIG. 2, the region integration portion 13 integrates the thin-line region and the serif region. Thereby, the integration result shown in FIG. 3E is obtained. The process returns to step S22 of FIG. 2 by updating the foreground feature vector, and the integration determination of the background region, the thin line and the serif region is performed by the integration determination portion 12. However, it is determined that the integration is not performed, and the termination determination portion 14 in step S24 determines that the termination condition is satisfied due to the integration not occurring. The process is then terminated and the integration result shown in FIG. 3E is output.

Although deterioration occurs in the boundary portion with the thin-line portion or the serif background of the image shown in FIG. 3A and the foreground color changes, the region of the original foreground color is extracted as shown in FIG. 3E. From this result, for example, the color of each of the color region may be replaced by the representative color of the corresponding color region to perform a color limiting process, a specific color region may be extracted, and each of them may be used in a process at a later stage.

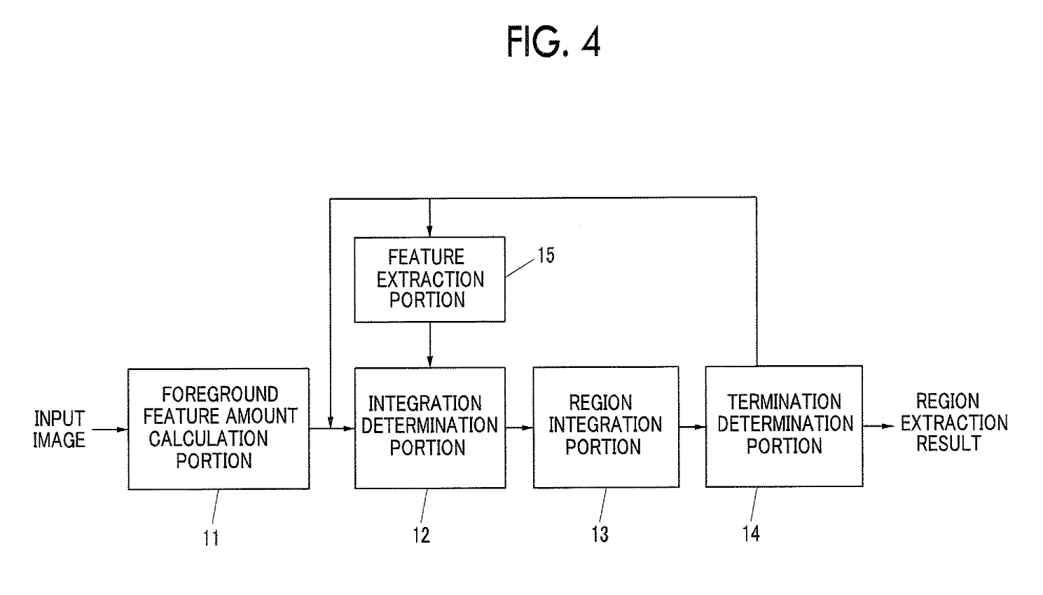

FIG. 4 is a configuration diagram illustrating a first modified example an first exemplary embodiment of the invention. In the drawing, 15 denotes a feature extraction portion. The feature extraction portion 15 extracts various feature amounts other than the foreground feature vector calculated in the foreground feature amount calculation portion 11 with respect to two regions or pixels to be integrated. As the feature amounts to be extracted, for example, there are the thickness, width, or length of the region, the color of the region or the pixel, the positional relationship, the degree of inclusion, the area, and the like. Of course, there may be other feature amounts.

For example, when the thickness is extracted as the feature amount to be extracted, the diameter (the number of pixels) of the maximum inscribed circle which is in contact with the inside of the region to be integrated may be obtained. For example, when a target to be integrated is a pixel, the thickness thereof may be set to 1.

In the integration determination portion 12, the similarity is calculated using the thickness extracted by the feature extraction portion 15 together with the foreground feature vector to be integrated, and whether the integration is performed may be determined. As a specific example, when the angle between two foreground feature vectors is set to θ, the length of each of the foreground feature vectors is set to D1 and D2, the thickness of each of the targets to be integrated is set to d1 and d2, and an increasing function is set to f, the similarity may be obtained by the following expressions.

Similarity=α·θ+β·|Δ|

Δ=D1/f(d1)−D2/f(d2)

Meanwhile, α and β are positive constants, and may be given in advance. As the value of the obtained similarity decreases, it is shown that the feature amounts become more similar to each other. When the similarity is smaller than a predetermined threshold, it may be determined that the integration is performed.

For this example, the thickness dl of the thin-line portion is smaller than the thickness d2 of the serif portion, for example, in the example shown in FIGS. 3A to 3E, the relationship of d1<d2 is satisfied. Although the relationship between the length D1 of the foreground feature vector in the thin-line portion and the length D2 of the foreground feature vector in the serif portion is D1<D2, the values of D1/f(d1) and D2/f(d2) which are the ratio of the length to the thickness are similar to each other. The directions of both foreground feature vectors are also similar to each other, and thus it is shown that both are similar to each other from the similarity obtained by the above-mentioned expressions. Even when the shapes are different from each other and the lengths of the foreground feature vectors are different from each other as with the thin line and the serif in this example, the probability of both being integrated is higher than that in the case where the thickness is not used.

In addition, when the color difference, the positional relationship, the degree of inclusion, and the area are used, for example, as the feature amounts to be extracted, the similarity may be obtained by a linear function using these feature amounts together with the similarity obtained from the foreground feature vector. For example, when the feature amount obtained from the foreground feature vector is set to F(θ, Δ) mentioned above, the color difference to be integrated is set to G, the positional relationship to be integrated is set to H, each of the degrees of inclusion to be integrated is set to c1 and c2, and each of the areas to be integrated is set to s1 and s2, the similarity may be obtained by the following expression.

Similarity=F(θ, Δ)+γ·G+δ·H−ε·I(c1, c2)+ζ·J(s1, s2) Meanwhile, γ, δ, ε, and ζ are positive constants, and may be given in advance. In addition, the function I and the function J are increasing functions. As the value of the obtained similarity decreases, it is shown that the feature amounts are more similar to each other. When the value of the similarity is smaller than a predetermined threshold, it may be determined that the integration is performed.

Here, the color difference G to be integrated is a Euclidean distance in the color space of each of the color to be integrated. As the Euclidean distance decreases, it is shown that the colors become more similar to each other, and the value of the similarity becomes smaller.

In addition, the distance between barycentric positions/area sum, the area sum/the length between adjacent portions, and the like of each of the regions or pixels to be integrated may be used as the positional relationship H to be integrated. When the region increases due to the integration, the distance between barycentric positions from other targets to be integrated increases, but is normalized by the area sum and reflected in the similarity. For the area sum/the length between adjacent portions, when the area increases due to the integration, the length in the periphery thereof also increases. Therefore, what extent of the portions are in contact with the periphery thereof is shown. As the length between the adjacent portions increases, the value of the similarity becomes smaller.

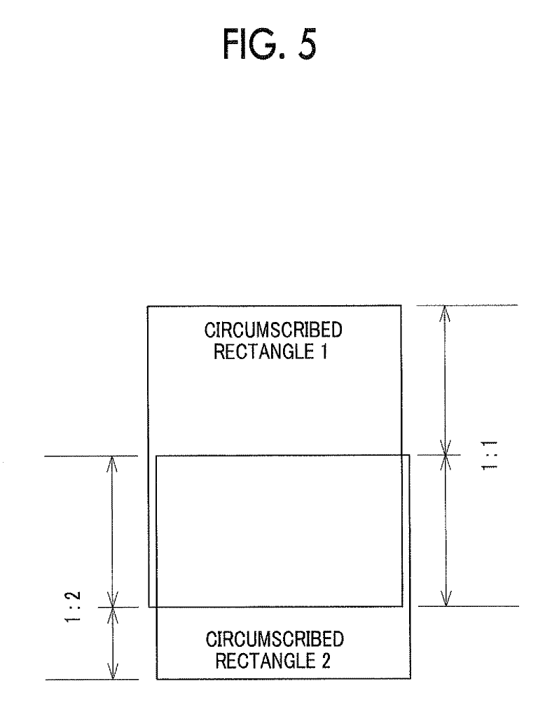

For the degrees of inclusion c1 and c2, the overlapping area ratio of circumscribed rectangles may be set to the degree of inclusion with respect to each of the targets to be integrated. FIG. 5 is an explanatory diagram illustrating an example of the degree of inclusion. Each of the circumscribed rectangles to be integrated is set to the circumscribed rectangle 1 and the circumscribed rectangle 2. For the circumscribed rectangle 1, the ratio of the area which overlaps the circumscribed rectangle 2 to the area which does not overlap it is set to 1:1. In this case, the degree of inclusion may be set to 1/2. In addition, for the circumscribed rectangle 2, the area which overlaps the circumscribed rectangle 1 to the area which does not overlap it is set to 2:1. In this case, the degree of inclusion may be set to 2/3. As the degree of inclusion increases, it is shown that the relationship between both strengthens. Using the increasing function I putting together these degrees of inclusion, the value becomes larger as the degree of inclusion increases. The similarity is set to the negative term, and the value of the similarity becomes smaller as the degree of inclusion increases.

The areas s1 and s2 are the areas (the number of pixels) of each of the regions to be integrated, and the increasing function J may be various functions of, for example, obtaining the sum. As the area decreases, the value of the similarity becomes smaller, and the integration with other regions or pixels is easily performed. For example, the portion in which the thin portion is deteriorated is integrated into the adjacent region.

Meanwhile, it goes without saying that the combination with the above-mentioned thickness maybe made. In addition, the similarity may be obtained using how much feature amount selectively, or using various other feature amounts together. Whether the integration of the targets to be integrated is performed may be determined using such feature amounts and the calculated similarity.

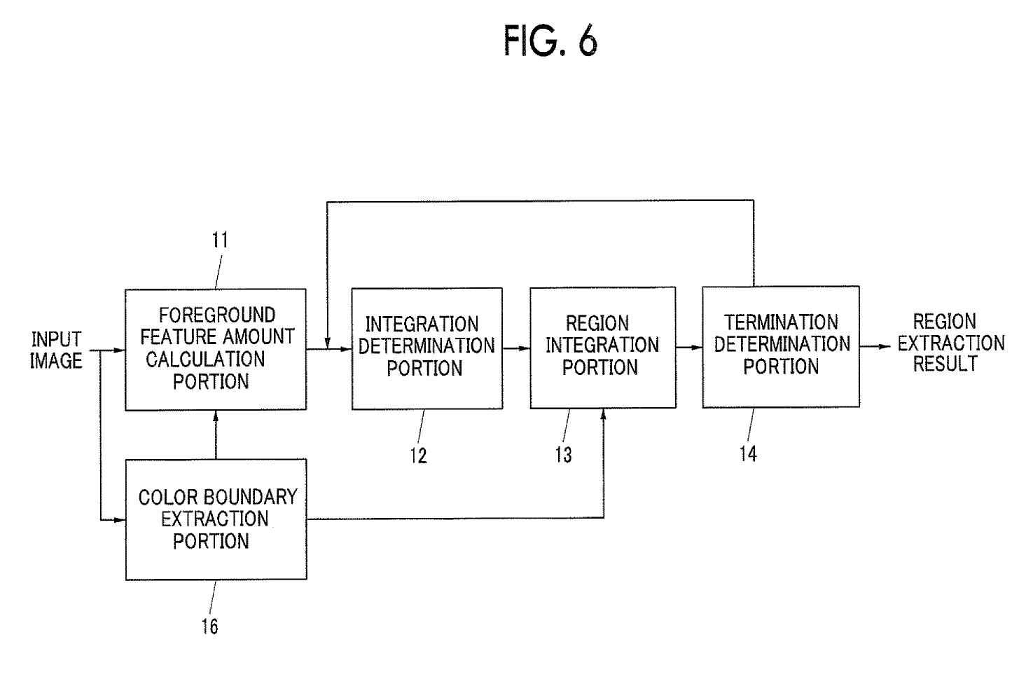

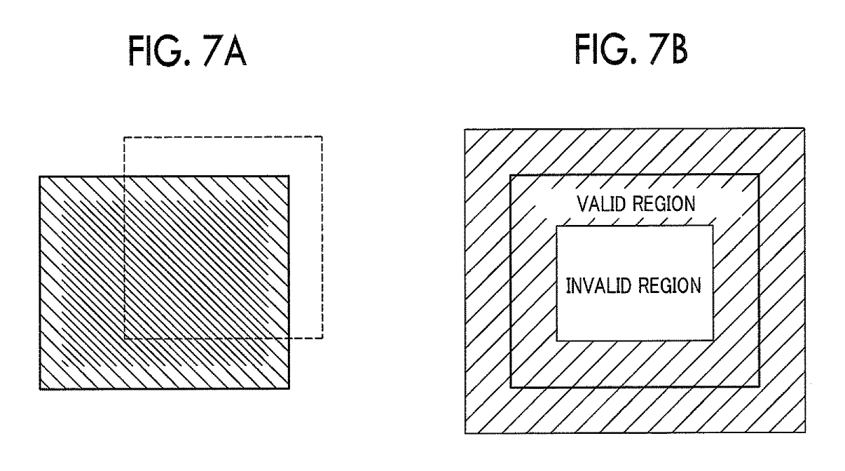

FIG. 6 is a configuration diagram illustrating a second modified example in the first exemplary embodiment of the invention. In the drawing, 16 denotes a color boundary extraction portion. The foreground feature vector obtained in the foreground feature amount calculation portion 11 is obtained as the vector in the color space from the average color of the pixels in the predetermined region to the color of the target pixel. For this reason, as the number of pixels other than the background color in the predetermined region increases, the background color is not obtained as the average color, and the vector from the background color to the color of the target pixel is not obtained as the foreground feature vector. In the second modified example, an example corresponding to such a case is shown.

The color boundary extraction portion 16 detects the difference in the colors of the image, and extracts the boundary of the difference in the colors as the color boundary. As methods of extracting the color boundary, various methods are known, and any of the methods may be used.

The foreground feature amount calculation portion 11 calculates the foreground feature vector with respect to pixels of a valid region, using pixels in the region predetermined from the color boundary extracted in the color boundary extraction portion 16 as the valid region. In addition, the integration determination portion 12 determines whether to integrate two pixels or regions to be integrated in the valid region, depending on the similarity of the foreground feature vectors. This determination is as described above. When two pixels or regions to be integrated in the region (invalid region) other than the valid region, or pixels or regions of the invalid region and pixels or regions of the valid region are targets to be integrated, whether the integration is performed by the method hitherto used may be determined. For example, it maybe determined that the integration is performed when the color difference is in the preset range, and it may be determined that the integration is not performed when the color difference is out of the preset range. Further, the region integration portion 13 integrates two pixels or regions determined to be integrated by the integration determination portion 12 into one region. However, when both of the pixels or the regions to be integrated are the pixels or the region of the valid region, the foreground feature vector of the integrated regions is calculated using both foreground feature vectors.

In the second modified example in the first exemplary embodiment of the invention shown in FIG. 6, the extraction result of the color boundary by the color boundary extraction portion 16 is further used in the region integration portion 13. In the region integration portion 13, when the integration is performed on the targets to be integrated, the integration is not performed crossing over the color boundary extracted in the color boundary extraction portion 16. Thereby, excessive integration is prevented.

FIG. 7 is an explanatory diagram illustrating a specific example of the second modified example in the first exemplary embodiment of the invention. In the example shown in FIG. 7A, the rectangle is drawn with the foreground color in the white background. In the color boundary between the rectangle and the background, the foreground color changes due to deterioration, and the state thereof is shown by the difference in the diagonal lines, for convenience of illustration.

The dashed line shows an example of the region predetermined in order to calculate the average color. For this example, since the number of the pixels of the foreground color is larger than the number of the pixels of the background color in the region of the dashed line, the average color is closer to the foreground color rather than the background color. For this reason, the foreground feature vector obtained in the pixel inside the foreground color is different from the foreground feature vector obtained in the pixel of the color boundary portion in direction and length.

In this second modified example, the pixels in the region predetermined from the color boundary extracted in the color boundary extraction portion 16 are set to the valid region. This valid region is drawn in a diagonal line as shown in FIG. 7B, and the portion drawn is shown as the valid region. The portion other than the valid region is set to the invalid region. This valid region may include pixels which are influenced by the color boundary and pixels which are not influenced thereby. In the pixels of the valid region, the color influenced by the background color is calculated as the average color when the foreground feature vector is obtained, and the integration process is performed using the above-mentioned foreground feature vector.

Meanwhile, for the invalid region, it is determined whether the integration is performed by the method the hitherto used, for example, depending on whether the color difference is in a preset range, and the pixels or the regions determined to be integrated may be integrated.

In the above-mentioned description, for the invalid region, the integration processing is performed by the method in which the foreground feature vector is not used. For example, for the pixels of the invalid region, the foreground feature vector of the valid region is copied from the pixels which are in contact with the valid region with no change, and the foreground feature vector is also set with respect to the pixels of the invalid region. Alternatively, the foreground feature vector is previously set as the region integrated for each region divided by the valid region, and the integration process making use of the foreground feature vector may also be performed with respect to the invalid region.

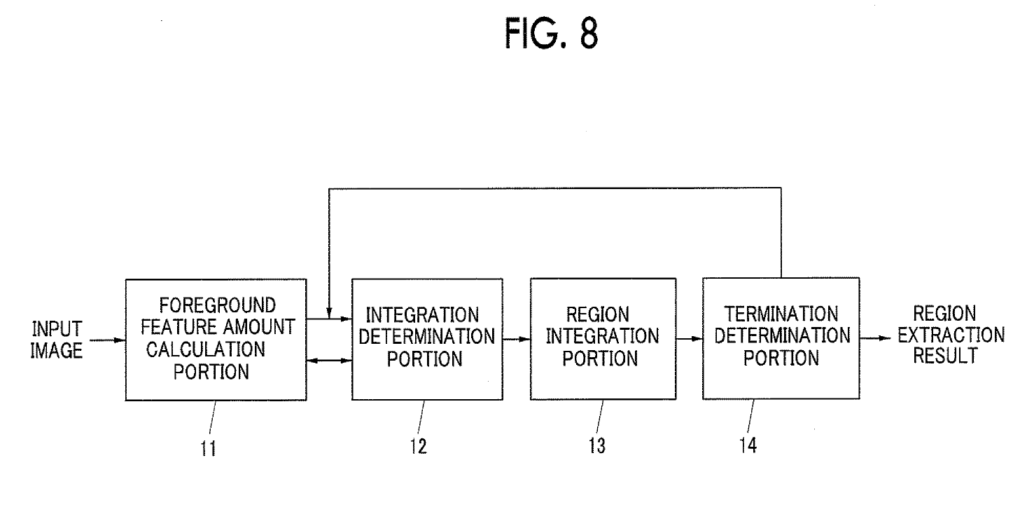

FIG. 8 is a configuration diagram illustrating a third modified example in the first exemplary embodiment of the invention. When the integrated region is in contact with regions having various colors, the foreground feature vector of the region is influenced by various colors with which the region is in contact. For this reason, when the integration with another region similar to the color of the corresponding region is determined, an incorrect determination may be performed.

In the third modified example, when the integration determination portion 12 determines the integration of two regions, the foreground feature amount calculation portion 11 re-calculates the foreground feature vector with respect to the pixels of the valid region, using the pixels in the region predetermined from the color boundary which is in contact with the corresponding region as the valid region. Alternatively, while the foreground feature vector initially calculated is maintained, the foreground feature vector is read out and transferred to the integration determination portion 12. In the integration determination portion 12, it is determined whether the integration is performed using the foreground feature vector of the valid region transferred from the foreground feature amount calculation portion 11.

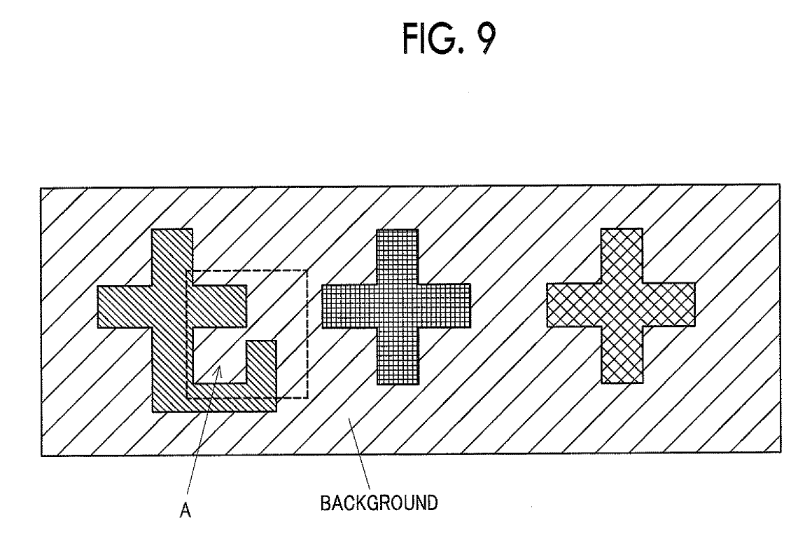

FIG. 9 is an explanatory diagram illustrating a specific example of the third modified example in the first exemplary embodiment of the invention. In the example shown in FIG. 9, three figures having different colors are drawn on a certain background color. The integration process proceeds, and the region A and the background portion in the drawing are selected as the targets to be integrated. The background portion is in contact with three figures having different colors, and thus the foreground feature vector is influenced by the colors of these figures. In addition, the foreground feature vector of the region A is influenced by the figure having one color. Therefore, when the integration of the region A and the background portion is determined as it is, it may be determined that the integration is not performed.

In such a case, the predetermined region shown by the dashed line in the drawing from both boundaries is set to the valid region, and the foreground feature vector is acquired from the foreground feature amount calculation portion 11. Thereby, the region A and the background region are also unified the foreground feature vector influenced by the figure having one color, and the integration determination is performed using this foreground feature vector. For example, as in the example shown in FIG. 9, the region inserted into another figure is also integrated with the original region.

When the size of, for example, at least one region is a predetermined size (for example, the number of pixels) or greater in addition to performing the setting of the valid region in the third modified example at the time of the integration of any of the regions, the valid region may be set to a region having the predetermined size or greater.

Alternatively, it is determined whether the foreground feature vector obtained for each of the pixels within the region is in a predetermined region, and the above-mentioned valid region may be set when it is not in a predetermined region. For example, in the example shown in FIG. 9, the pixels integrated into the background portion are also influenced by the color of each of the figures in the region which is in contact with each of the three figures, and the foreground feature vector is also influenced by each of the figures. For this reason, although integrated into the background portion, the original foreground feature vector before the integration deviates from the foreground feature vector of the region after the integration, and the deviation is different depending on which color of the figure is exerting influence. It is determined whether the foreground feature vector is in a predetermined region, on consideration of the variation in the foreground feature vector due to such deviation. When the foreground feature vector is not in a predetermined region, it is considered that the corresponding region is a collection of the pixels influenced by various types of colors, and thus incorrect determination may be prevented by setting the above-mentioned valid region. When the foreground feature vector is in a predetermined region, the influence of various colors may be not considered, and the integration determination and the integration process may be performed using the foreground feature vector of the corresponding region, without performing the setting of the valid region or the re-calculation of the foreground feature vector of the valid region. Meanwhile, in the foreground feature vector in each of the pixels within the region, the foreground feature vector initially calculated is maintained before the integration process, and the foreground feature vector may be read out and used.

Alternatively, it is determined whether the foreground feature vector obtained for each of the pixels within the region is in a predetermined region, and the integration determination or the integration making use of the foreground feature vector may be not performed when the foreground feature vector is not in a predetermined region. As described above, when the foreground feature vector previously obtained for each of the pixels within the region is varied, it is shown that the foreground feature vector is influenced by various colors. For this reason, it is determined that the foreground feature vector of the corresponding region is not accurately obtained, and the integration determination or the integration process making use of the foreground feature vector is not performed. For example, it is determined whether the integration is performed by the method hitherto used in which the integration is performed when the color difference is in a preset range and the integration is not performed when the color difference is out of a preset range, and then the integration process may be performed. In this case, in the foreground feature vector in each of the pixels within the region, the foreground feature vector initially calculated is maintained before the integration process, and the foreground feature vector may be read out and used.

In addition, since the region having a predetermined size (for example, the number of pixels) or greater may be influenced by various colors, the integration determination or integration process making use of the foreground feature vector of the corresponding region is not performed. For example, the integration determination and the integration process may be performed by the method, hitherto used, such as the integration determination and the integration process making use of the color difference.

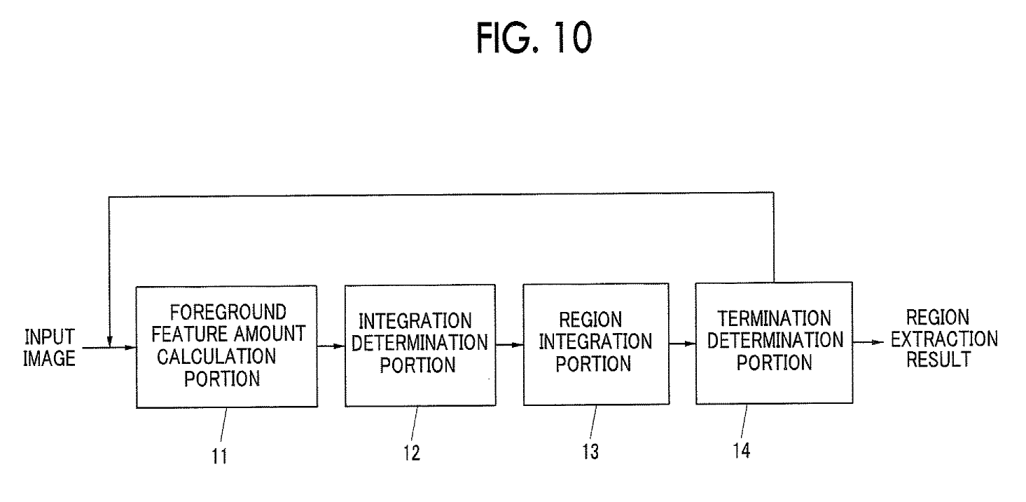

FIG. 10 is a configuration diagram illustrating a second exemplary embodiment of the invention. The second exemplary embodiment is different from the above-mentioned first exemplary embodiment in that which vector is calculated as the foreground feature vector. Portions different from those of the above-mentioned first exemplary embodiment will be chiefly described.

The foreground feature amount calculation portion 11 calculates the average color of each of the regions, and calculates the foreground feature vector. For the pixel which is not yet integrated, the color of the pixel is the average color. The foreground feature amount calculation portion 11 sets pixels or regions adjacent to the target region in which the target pixel or the pixel is integrated as peripheral pixels or peripheral regions, obtains a color difference vector in the color space from the color of each of the peripheral pixels or the peripheral regions to the color (average color) of the target pixel or the target region, and calculates the average of the color difference vectors as the foreground feature vector. Further, the foreground vector may be calculated using the area of the peripheral region (peripheral pixel), the connection length between the target region (target pixel) and the peripheral region (peripheral pixel), or the like. For example, the foreground feature vector may be calculated by the following expression.

Foreground feature vector=average of (color difference vector·area·connection length)

The color difference vector is changed depending on the size of the peripheral region, or to what extent the contact with the peripheral pixel or the peripheral region is made, and the foreground feature vector is obtained by the average of the color difference vector after the change. Meanwhile, when the color difference vector is varied and is not in a preset region, the integration determination portion 12 is notified of the purport.

In the integration determination portion 12, it is determined whether the integration is performed on two pixels or regions to be integrated, using the foreground feature vector calculated in the foreground feature amount calculation portion 11. When the foreground feature amount calculation portion 11 notifies the integration determination portion 12 of the combination of the pixels or the regions in which the color difference vector is not in a preset region at the time of the determination, it is determined that the integration is not performed.

Meanwhile, in the second exemplary embodiment, the foreground feature vector is not updated in the region integration portion 13. When it is determined that the integration process is performed in the region integration portion 13, and the process is further repeated in the termination determination portion 14, the process is repeated returning to the foreground feature amount calculation portion 11.

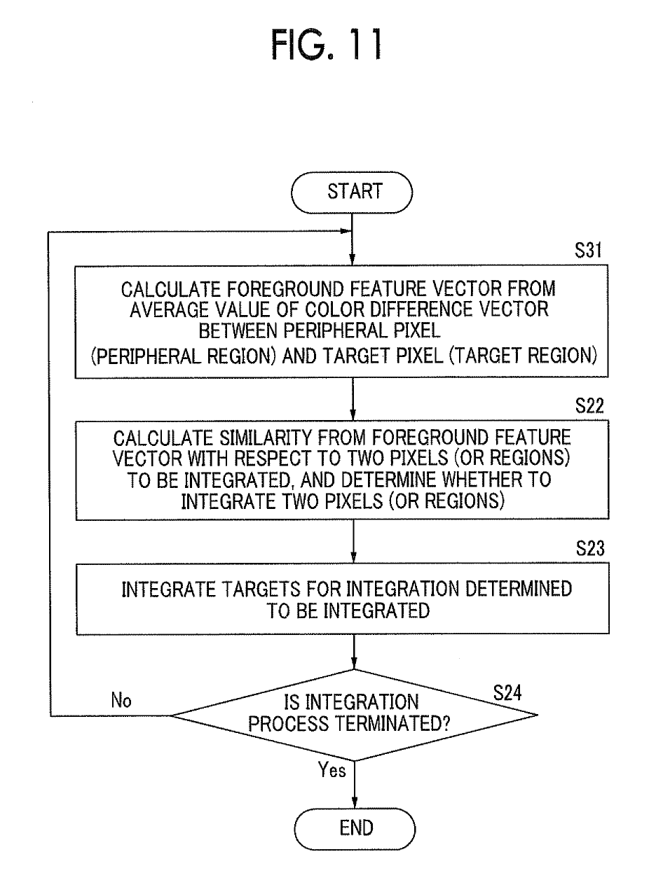

FIG. 11 is a flow diagram illustrating an example of an operation in the second exemplary embodiment of the invention. Processes different from an example of the operation in the first exemplary embodiment mentioned above will be chiefly described. In step S31, the foreground feature amount calculation portion 11 calculates the average color of each of the regions, and calculates the foreground feature vector. Initially, the calculation of the average color is unnecessary, and the color of the pixel is the average color. The foreground feature vector sets each of the pixel to the target pixel, sets the pixel adjacent to the target pixel as the peripheral pixel, and obtains the color difference vector in the color space from the peripheral pixel to the target pixel. Initially, this color difference vector may be set to the foreground feature vector. A region composed of plural pixels is generated by the second or subsequent integration process. For the region, the average color is calculated and is set to the color of the corresponding region. Each of the color difference vectors from the colors of the pixels (peripheral pixels) or the regions (peripheral regions) adjacent to the target pixel or the target region to the color (average color) of the target pixel or the target region is obtained. For the vector based on the obtained color difference vector, or further the area of the peripheral region (peripheral pixel), the connection length between the peripheral region (peripheral pixel), or the like, it is preferable that the foreground feature vector is calculated by obtaining the average.

In step S22, the integration determination portion 12 determines whether to integrate two pixels or regions to be integrated, depending on the similarity of the foreground feature vectors with respect to the two pixels or regions. As a determination method, the method described in the above-mentioned first exemplary embodiment may be used. Further, when the color difference vector used at the time of calculating the foreground feature vector in step S31 is varied and is not in a preset region, it is determined that the integration is not performed by receiving notification of the purport from the integration determination portion 12.

In step S23, the region integration portion 13 integrates two pixels or regions determined to be integrated by the integration determination portion 12 into one region. The integration process is as described in the above-mentioned first exemplary embodiment, but the foreground feature vector is not updated.

In step S24, the termination determination portion 14 determines whether the integration process is terminated. The termination determination is as described in the above-mentioned first exemplary embodiment. When the termination condition is not satisfied, in the second exemplary embodiment, the process returns to step S31 and the process is repeated.

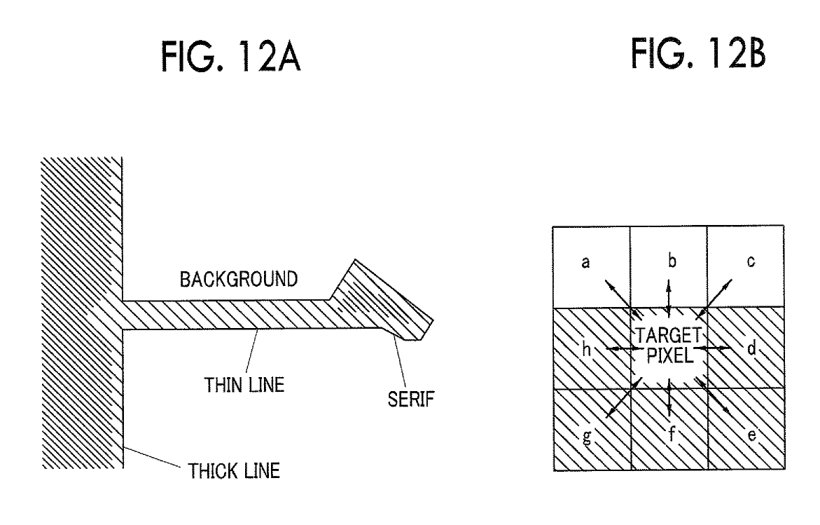

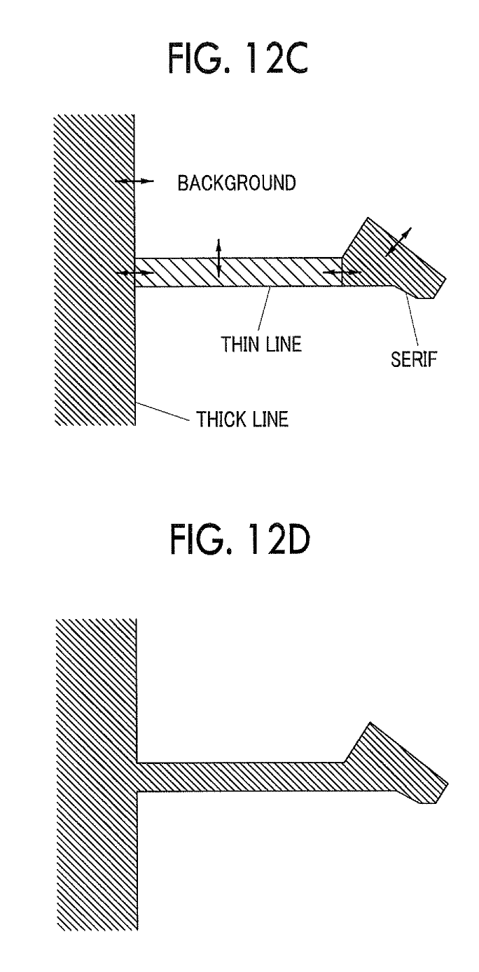

FIGS. 12A and 12D are explanatory diagrams illustrating a specific example of the operation in the second exemplary embodiment of the invention. FIG. 12A shows a portion of an image to be processed. In this example, a serif used in characters in the Mincho typeface with a certain foreground color is present in the thin line and the termination portion on one end side thereof, in the white background, and the termination portion on the other end side thereof is connected to the line thicker (referred to as the thick line) than the thin line. In this example, the color of the boundary portion between the thin-line portion and the white background of the serif and the thick line is lighter than the original foreground color under the influence of the white background due to various deterioration factors. For convenience of illustration, the difference in the colors is shown as the difference in the diagonal lines.

In step S31 of FIG. 11, the foreground feature amount calculation portion 11 calculates the foreground feature vector in each of the pixels. Meanwhile, initially, the color of each of the pixels becomes the average color. For example, in the pixel which is in contact with the background of the thin line, the color difference vectors between the color of the pixel and the colors of pixels adjacent in eight directions shown in FIG. 12B centered on the pixel are obtained, and the average vector is set to the foreground feature vector. In the example shown in FIG. 12B, pixels shown as a, b, and c are pixels of the background color, and pixels shown as d, e, f, g, and h are pixels of the foreground color influenced by the background color. The foreground feature vector is calculated by averaging the color difference vectors of these pixels. Meanwhile, in the pixel of the boundary portion between the serif and the background of the thick line, the average of the color difference vectors between the pixel of the background color and the pixel of the foreground color influenced by the background, or further the average of the color difference vectors between the color of the background color and the pixel of the foreground color which is not influenced by the background becomes the foreground feature vector. For the serif and the interior of the thick line, the average of the color difference vectors between the pixels of the foreground color is set to the foreground feature vector. Meanwhile, for the background, in the boundary portion with the foreground color, the average including the color difference vectors for the foreground color is set to the foreground feature vector.

In the determination process of the integration made by the integration determination portion 12 in step S22 of FIG. 11, when it is determined that the integration is performed by the combination of the adjacent pixels, the boundary portion between the thin-line portion, the serif, or the background of the thick line is determined to be integrated. In addition, the serif and the interior of the thick line are determined to be integrated. These are integrated by the region integration portion 13 in step S23 of FIG. 11. Meanwhile, in step S24 of FIG. 11, the termination determination portion 14 determines that the termination condition is not satisfied, and the process returns to step S31 of FIG. 11 again.

In step S31, the foreground feature amount calculation portion 11 obtains the average color with respect to each of the regions after the integration. For the pixel itself in which the integration is not performed, the color of the pixel maybe set to the average color. The foreground feature vectors of each of the regions and each of the pixels are calculated. In the example shown in FIG. 12C, a state is shown in which the thin-line portion, the serif portion, the thick-line portion, and the background portion are respectively integrated. Each of the average colors is obtained with respect to these portions. The foreground feature vector of each of the portions is then calculated. For example, in the state as shown in FIG. 12C, the thin-line portion is in contact with the serif portion, the thick-line portion, and the background portion. Therefore, the color difference vector between these portions is obtained and averaged, and is set to the foreground feature vector. In addition, since the thick-line portion is in contact with the thin line and the background portion, each of the color difference vectors is obtained and averaged, and is set to the foreground feature vector. Further, since the serif portion is in contact with the thin line and the background portion, each of the color difference vectors is obtained and averaged, and is set to the foreground feature vector. Meanwhile, since the background is in contact with the thick-line portion, the thin-line portion, and the serif portion, each of the color difference vectors is obtained and averaged, and thus the foreground feature vector is obtained.

When the foreground feature vector is calculated, in step S22, it is determined whether the integration is performed by calculating the similarity of the foreground feature vectors by the integration determination portion 12. In the state as shown in FIG. 12C, the foreground feature vectors of the thick-line portion, the thin-line portion, and the serif portion are similar to each other, it is determined that the integration is performed. In the determination of the integration of the background portion with each of the portions of the thick line, the thin line, and the serif, the directions of the foreground feature vectors are different from each other, and thus it is determined that the integration is not performed.

According to this determination result, in step S23, the thick-line portion, the thin-line portion, and the serif portion are integrated with each other by the region integration portion 13. Thereby, the integration result shown in FIG. 12D is obtained. Return to steps S24 to S31, the process is repeated. When the termination condition is satisfied, the process is terminated. For example, in the example shown in FIGS. 12A to 12D, the integration result shown in FIG. 12D is output.

In the image shown in FIG. 12A, deterioration occurs in the boundary portion between the thin-line portion and the serif background, the foreground color changes. For the thin line, the original foreground color does not remain. However, as the integration result, each of the portions of the thick line, the thin line, and the serif are integrated with each other, and the portion of the original foreground color before deterioration occurs is extracted. From this result, for example, the color of each of the color region may be replaced by the representative color of the corresponding color region to perform a color limiting process, a specific color region may be extracted, and each of them may be used in a process at a later stage.

Meanwhile, in the second exemplary embodiment of the invention, it may be configured such that the feature extraction portion 15 described as the first modified example in the first exemplary embodiment of the invention mentioned above is provided, and various feature amounts other than the features such as the area and the connection length used at the time of the calculation of the foreground feature vector and the foreground feature vector mentioned above are extracted and used at time of the determination of the integration by the integration determination portion 12. In addition, it may be configured such that the color boundary extraction portion 16 described as the second modified example in the first exemplary embodiment of the invention mentioned above is provided, and the region integration is performed so as not to cross over the color boundary at the time of the integration by the region integration portion 13. Of course, it may be configured such that the both are included in the configuration.

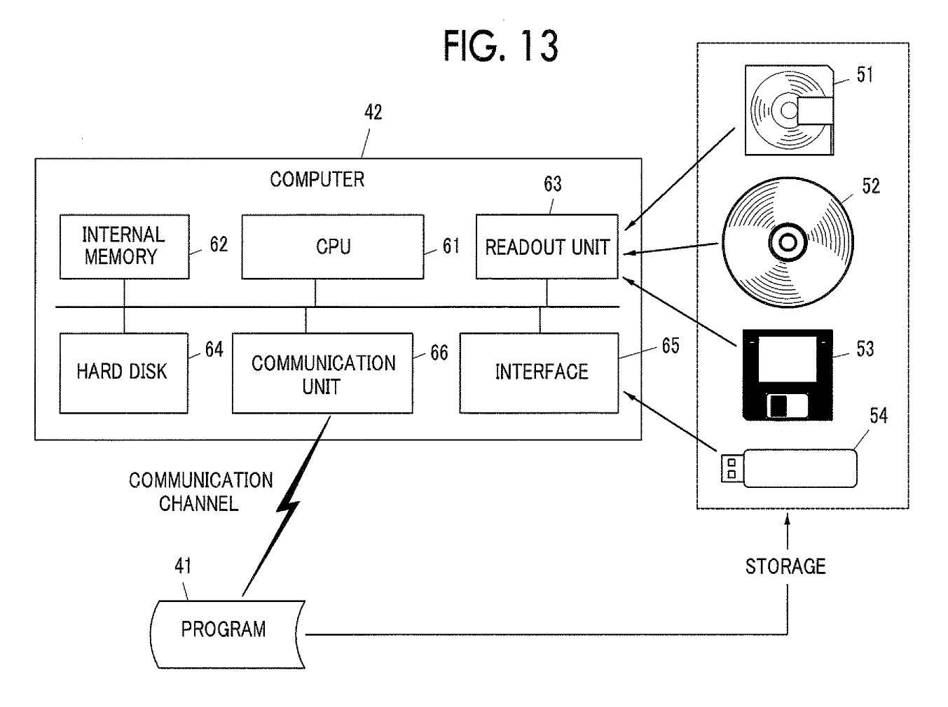

FIG. 13 is an explanatory diagram illustrating an example of a computer program when functions described in each of the exemplary embodiments of the invention and the modified examples thereof are realized by a computer program, a recording medium having the computer program stored thereon, and a computer. In the drawing, 41 denotes a program, 42 denotes a computer, 51 denotes a magneto-optical disc, 52 denotes an optical disc, 53 denotes a magnetic disk, 54 denotes a memory, 61 denotes a CPU, 62 denotes an internal memory, 63 denotes a readout unit, 64 denotes a hard disk, 65 denotes an interface, and 66 denotes a communication unit.

The function of each of the units described in each of the exemplary embodiments of the invention and the modified examples thereof mentioned above maybe entirely or partially realized by the program 41 for causing a computer to execute the function. In that case, the program 41, data used by the program and the like may be stored in a recording medium read out by a computer. The recording medium is a medium that causes change states of magnetic, optical, and electrical energy or the like in response to the content description of a program with respect to the readout unit 63 included in hardware resources of a computer, and transfers the content description of a program to the readout unit 63 in the form of signals corresponding thereto. For example, the recording medium includes the magneto-optical disk 51, the optical disk 52 (including a CD, a DVD and the like), the magnetic disk 53, the memory 54 (including an IC card, a memory card, a flash memory and the like) and the like. Of course, the recording medium is not limited to a portable type.

When the program 41 is stored in such a recording medium, the program 41 is read out from a computer, for example, by mounting the recording medium in the readout unit 63 or the interface 65 of the computer 42 and is stored in the internal memory 62 or the hard disk 64 (including a magnetic disk or a silicon disk and the like), and the function described in each of the exemplary embodiments of the invention and the modified examples thereof mentioned above is all or partially realized by executing the program 41 using the CPU 61. Alternatively, the program 41 is transferred to the computer 42 through a transmission channel, the program 41 is received in the communication unit 66 of the computer 42 and is stored in the internal memory 62 or the hard disk 64, and the above-mentioned function may be realized by executing the program 41 using the CPU 61.

The computer 42 may be connected to various devices through another interface 55. The region extraction result after the process may be transferred to another program, may be stored in the hard disk 64, may be stored on a recording medium through the interface 65, or may be transferred to the outside through the communication portion 66. Of course, the configuration may be partially configured by hardware, and may be entirely configured by hardware. Alternatively, the configuration may be configured as a program including all or a portion of the functions described in each of the exemplary embodiments of the invention and the modified examples thereof along with another configuration. Of course, when the configuration is applied to another application, it may be integrated with a program in the application.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image processing apparatus comprising:
at least one processor:
at least one memory, the memory storing instructions that when executed cause the at least one processor to perform as:
a calculation unit that calculates, as a foreground feature vector, a feature vector indicating a difference between colors of pixels in a predetermined region including a target pixel and a color of the target pixel, using each of the pixels as the target pixel;
a determination unit that determines whether to integrate two pixels or regions to be integrated, depending on similarity of the foreground feature vectors with respect to the two pixels or regions; and
an integration unit that integrates the two pixels or regions determined to be integrated by the determination unit.

2. The image processing apparatus according to claim 1, wherein the calculation unit calculates, as the foreground feature vector, a vector in a color space from an average color of the colors of the pixels in the predetermined region to the color of the target pixel.

3. The image processing apparatus according to claim 2, wherein the calculation unit calculates the foreground feature vector with respect to pixels of a valid region, using pixels in a region predetermined from a color boundary as the valid region.

4. The image processing apparatus according to claim 2, wherein the calculation unit calculates the foreground feature vector with respect to pixels of a valid region, using pixels in a region predetermined from a boundary of colors to be integrated as the valid region.

5. The image processing apparatus according to claim 1, wherein the calculation unit notifies the determination unit that the foreground feature vector before integration in each of the pixels of the target region is not in a preset region, and the determination unit determines not to perform integration on a combination of pixels or regions in which a color difference vector is not in a preset region.

6. The image processing apparatus according to claim 2, wherein the calculation unit notifies the determination unit that the foreground feature vector before integration in each of the pixels of the target region is not in a preset region, and the determination unit determines not to perform integration on a combination of pixels or regions in which a color difference vector is not in a preset region.

7. The image processing apparatus according to claim 3, wherein the calculation unit notifies the determination unit that the foreground feature vector before integration in each of the pixels of the target region is not in a preset region, and the determination unit determines not to perform integration on a combination of pixels or regions in which a color difference vector is not in a preset region.

8. The image processing apparatus according to claim 4, wherein the calculation unit notifies the determination unit that the foreground feature vector before integration in each of the pixels of the target region is not in a preset region, and the determination unit determines not to perform integration on a combination of pixels or regions in which a color difference vector is not in a preset region.

9. The image processing apparatus according to claim 1, wherein when two pixels or regions are integrated, the integration unit calculates a foreground feature vector of the integrated region using the both foreground feature vectors.

10. The image processing apparatus according to claim 2, wherein when two pixels or regions are integrated, the integration unit calculates a foreground feature vector of the integrated region using the both foreground feature vectors.

11. The image processing apparatus according to claim 3, wherein when two pixels or regions are integrated, the integration unit calculates a foreground feature vector of the integrated region using the both foreground feature vectors.

12. The image processing apparatus according to claim 4, wherein when two pixels or regions are integrated, the integration unit calculates a foreground feature vector of the integrated region using the both foreground feature vectors.

13. The image processing apparatus according to claim 5, wherein when two pixels or regions are integrated, the integration unit calculates a foreground feature vector of the integrated region using the both foreground feature vectors.

14. The image processing apparatus according to claim 6, wherein when two pixels or regions are integrated, the integration unit calculates a foreground feature vector of the integrated region using the both foreground feature vectors.

15. The image processing apparatus according to claim 1, wherein the calculation unit calculates, as the foreground feature vector, an average of the color difference vectors in the color space from a color of each peripheral pixel or peripheral region to a color of the target pixel or the target region, using pixels or regions adjacent to the target region in which the target pixel or the pixel is integrated as the peripheral pixel or the peripheral region.

16. The image processing apparatus according to claim 15, wherein the calculation unit calculates the average of the color difference vectors, further using a connection length between the target pixel or the target region and the peripheral pixel or the peripheral region, and sets the average to the foreground feature vector.

17. The image processing apparatus according to claim 15, wherein the calculation unit notifies the determination unit that the color difference vector is not in a preset region, and the determination unit determines not to perform integration on a combination of pixels or regions in which the color difference vector is not in a preset region.

18. The image processing apparatus according to claim 1, further comprising:
an extraction unit that extracts a color boundary, wherein the determination unit determines that two pixels or regions which do not cross over the color boundary extracted in the extraction unit are integrated.

19. A non-transitory computer readable medium storing a program causing a computer to execute the following steps:
calculating, as a foreground feature vector, a feature vector indicating a difference between colors of pixels in a predetermined region including a target pixel and a color of the target pixel, using each of the pixels as the target pixel;
determining whether to integrate two pixels or regions to be integrated, depending on similarity of the foreground feature vectors with respect to the two pixels or regions; and
integrating the two pixels or regions determined to be integrated.

20. A processor implemented image processing method comprising:
calculating using the processor, as a foreground feature vector, a feature vector indicating a difference between colors of pixels in a predetermined region including a target pixel and a color of the target pixel, using each of the pixels as the target pixel;
determining whether to integrate two pixels or regions to be integrated, depending on similarity of the foreground feature vectors with respect to the two pixels or regions; and
integrating the two pixels or regions determined to be integrated.
